(19) United States
(12) Patent Application Publication
(10) Pub. No.: US 2006/0285531 A1
(43) Pub. Date: Dec. 21, 2006

(54) Efficient filter weight computation for a MIMO system

(76) Inventors: Steven J. Howard, Ashland, MA (US); John W. Ketchum, Harvard, MA (US); Mark S. Wallace, Bedford, MA (US); Peter Monsen, Wellesley, MA (US); Jay Rodney Walton, Carlisle, MA (US)

Correspondence Address: QUALCOMM INCORPORATED, 5775 MOREHOUSE DR., SAN DIEGO, CA, 92121, US

(21) Appl. No.: 11/158,586

(22) Filed: Jun. 21, 2005

Related U.S. Application Data
(60) Provisional application No. 60/691,756, filed on Jun. 16, 2005.

(51) Int. Cl. H04J 1/00; H04L 1/02

(52) U.S. Cl. 370/343; 375/267

(57) ABSTRACT

Techniques to efficiently derive a spatial filter matrix are described. In a first scheme, a Hermitian matrix is iteratively derived based on a channel response matrix, and a matrix inversion is indirectly calculated by deriving the Hermitian matrix iteratively. The spatial filter matrix is derived based on the Hermitian matrix and the channel response matrix. In a second scheme, multiple rotations are performed to iteratively obtain first and second matrices for a pseudo-inverse matrix of the channel response matrix. The spatial filter matrix is derived based on the first and second matrices. In a third scheme, a matrix is formed based on the channel response matrix and decomposed to obtain a unitary matrix and a diagonal matrix. The spatial filter matrix is derived based on the unitary matrix, the diagonal matrix, and the channel response matrix.

### BACKGROUND

I. Field

The present disclosure relates generally to communication, and more specifically to techniques for computing filter weights in a communication system.

II. Background

A multiple-input multiple-output (MIMO) communication system employs multiple (T) transmit antennas at a transmitting station and multiple (R) receive antennas at a receiving station for data transmission. A MIMO channel formed by the T transmit antennas and the R receive antennas may be decomposed into S spatial channels, where S≦min {T, R}. The S spatial channels may be used to transmit data in a manner to achieve higher overall throughput and/or greater reliability.

The transmitting station may simultaneously transmit T data streams from the T transmit antennas. These data streams are distorted by the MIMO channel response and further degraded by noise and interference. The receiving station receives the transmitted data streams via the R receive antennas. The received signal from each receive antenna contains scaled versions of the T data streams sent by the transmitting station. The transmitted data streams are thus dispersed among the R received signals from the R receive antennas. The receiving station would then perform receiver spatial processing on the R received signals with a spatial filter matrix in order to recover the transmitted data streams.

The derivation of the weights for the spatial filter matrix is computationally intensive. This is because the spatial filter matrix is typically derived based on a function that contains a matrix inversion, and direct calculation of the matrix inversion is computationally intensive.

There is therefore a need in the art for techniques to efficiently compute the filter weights.

### SUMMARY

Techniques for efficiently computing the weights for a spatial filter matrix are described herein. These techniques avoid direct computation of matrix inversion.

In a first embodiment for deriving a spatial filter matrix M, a Hermitian matrix P is iteratively derived based on a channel response matrix H, and a matrix inversion is indirectly calculated by deriving the Hermitian matrix iteratively. The Hermitian matrix may be initialized to an identity matrix. One iteration is then performed for each row of the channel response matrix, and an efficient sequence of calculations is performed for each iteration. For the i-th iteration, an intermediate row vector aᵢ is derived based on a channel response row vector hᵢ, which is the i-th row of the channel response matrix. A scalar rᵢ is derived based on the intermediate row vector and the channel response row vector. An intermediate matrix Cᵢ is also derived based on the intermediate row vector. The Hermitian matrix is then updated based on the scalar and the intermediate matrix. After all of the iterations are completed, the spatial filter matrix is derived based on the Hermitian matrix and the channel response matrix.

In a second embodiment, multiple rotations are performed to iteratively obtain a first matrix P^{1/2} and a second matrix B for a pseudo-inverse matrix of the channel response matrix. One iteration is performed for each row of the channel response matrix. For each iteration, a matrix Y containing the first and second matrices from the prior iteration is formed. Multiple Givens rotations are then performed on matrix Y to zero out elements in the first row of the matrix to obtain updated first and second matrices for the next iteration. After all of the iterations are completed, the spatial filter matrix is derived based on the first and second matrices.

In a third embodiment, a matrix X is formed based on the channel response matrix and decomposed (e.g., using eigenvalue decomposition) to obtain a unitary matrix V and a diagonal matrix Λ. The decomposition may be achieved by iteratively performing Jacobi rotations on matrix X. The spatial filter matrix is then derived based on the unitary matrix, the diagonal matrix, and the channel response matrix.

Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout.

FIGS. 1, 2 and 3 show processes for computing an MMSE spatial filter matrix based on the first, second, and third embodiments, respectively.

FIG. 4 shows a block diagram of an access point and a user terminal.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The filter weight computation techniques described herein may be used for a single-carrier MIMO system and a multi-carrier MIMO system. Multiple carriers may be obtained with orthogonal frequency division multiplexing (OFDM), interleaved frequency division multiple access (IFDMA), localized frequency division multiple access (LFDMA), or some other modulation technique. OFDM, IFDMA, and LFDMA effectively partition the overall system bandwidth into multiple (K) orthogonal frequency subbands, which are also called tones, subcarriers, bins, and frequency channels. Each subband is associated with a respective subcarrier that may be modulated with data. OFDM transmits modulation symbols in the frequency domain on all or a subset of the K subbands. IFDMA transmits modulation symbols in the time domain on subbands that are uniformly spaced across the K subbands. LFDMA transmits modulation symbols in the time domain and typically on adjacent subbands. For clarity, much of the following description is for a single-carrier MIMO system with a single subband.

A MIMO channel formed by multiple (T) transmit antennas at a transmitting station and multiple (R) receive antennas at a receiving station may be characterized by an R×T channel response matrix H, which may be given as:

$$\underline{H} = [ \begin{matrix}{h}_{1 , 1} & {h}_{1 , 2} & ⋯ & {h}_{1 , T} \\ {h}_{2 , 1} & {h}_{2 , 2} & ⋯ & {h}_{2 , T} \\ ⋮ & ⋮ & ⋰ & ⋮ \\ {h}_{R , 1} & {h}_{R , 2} & ⋯ & {h}_{R , T}\end{matrix} ] = [ \begin{matrix}{\underline{h}}_{1} \\ {\underline{h}}_{2} \\ ⋮ \\ {\underline{h}}_{R}\end{matrix} ] , \qquad Eq ( 1 )$$

where
h_{i,j}, for i=1, . . . , R and j=1, . . . , T, denotes the coupling or complex channel gain between transmit antenna j and receive antenna i; and
hᵢ is a 1×T channel response row vector for receive antenna i, which is the i-th row of H.
   For simplicity, the following description assumes that the MIMO channel is full rank and that the number of spatial channels (S) is given as: S=T≦R.

The transmitting station may transmit T modulation symbols simultaneously from the T transmit antennas in each symbol period. The transmitting station may or may not perform spatial processing on the modulation symbols prior to transmission. For simplicity, the following description assumes that each modulation symbol is sent from one transmit antenna without any spatial processing.

The receiving station obtains R received symbols from the R receive antennas in each symbol period. The received symbols may be expressed as:
r=H·s+n, Eq (2)
where
s is a T×1 vector with T modulation symbols sent by the transmitting station;
r is an R×1 vector with R received symbols obtained by the receiving station from the R receive antennas; and
n is an R×1 vector of noise.
   For simplicity, the noise may be assumed to be additive white Gaussian noise (AWGN) with a zero mean vector and a covariance matrix of σₙ²·I, where σₙ² is the variance of the noise and I is the identity matrix.

The receiving station may use various receiver spatial processing techniques to recover the modulation symbols sent by the transmitting station. For example, the receiving station may perform minimum mean square error (MMSE) receiver spatial processing, as follows:
ŝ=(σₙ²·I+H^{H}·H)⁻¹·H^{H}·r=P·H^{H}·r=M·r, Eq (3)
where
M is a T×R MMSE spatial filter matrix;
P is a T×T Hermitian covariance matrix for the estimation error s-ŝ;
ŝ is a T×1 vector that is an estimate of s; and
“^{H}” denotes a conjugate transpose.
   The covariance matrix P may be given as P=E[(s-ŝ)·(s-ŝ)^{H}], where E[ ] is an expectation operation. P is also a Hermitian matrix whose off-diagonal elements have the following properties p_{j,i}=p_{i,j}*, where “*” denotes a complex conjugate.

As shown in equation (3), the MMSE spatial filter matrix M has a matrix inverse calculation. Direct calculation of the matrix inversion is computationally intensive. The MMSE spatial filter matrix may be more efficiently derived based on the embodiments described below, which indirectly calculate the matrix inversion with an iterative process instead of directly calculating the matrix inversion.

In a first embodiment of computing the MMSE spatial filter matrix M, the Hermitian matrix P is computed based on the Riccati equation. Hermitian matrix P may be expressed as:

$$\underline{P} = {( {σ}_{n}^{2} \cdot \underline{I} + {\underline{H}}^{H} \cdot \underline{H} )}^{- 1} = {( {σ}_{n}^{2} \cdot \underline{I} + {\sum }_{k = 1}^{R} {\underline{h}}_{k}^{H} \cdot {\underline{h}}_{k} )}^{- 1} . \qquad Eq ( 4 )$$

A T×T Hermitian matrix Pᵢ may be defined as:

$$\begin{matrix}{\underline{P}}_{i} = {( {σ}_{n}^{2} \cdot \underline{I} + {\sum }_{k = 1}^{i} {\underline{h}}_{k}^{H} \cdot {\underline{h}}_{k} )}^{- 1} , \\ = {( {σ}_{n}^{2} \cdot \underline{I} + {\sum }_{k = 1}^{i - 1} {\underline{h}}_{k}^{H} \cdot {\underline{h}}_{k} + {\underline{h}}_{i}^{H} \cdot {\underline{h}}_{i} )}^{- 1} , \\ = {( {\underline{P}}_{i - 1}^{- 1} + {\underline{h}}_{i}^{H} \cdot {\underline{h}}_{i} )}^{- 1} ,\end{matrix} \qquad Eq ( 5 )$$

The matrix inversion lemma may be applied to equation (5) to obtain the following:

$${\underline{P}}_{i} = {\underline{P}}_{i - 1} - \frac{{\underline{P}}_{i - 1} \cdot {\underline{h}}_{i}^{H} \cdot {\underline{h}}_{i} \cdot {\underline{P}}_{i - 1}}{{r}_{i}} \\ and \\ {r}_{i} = 1 + {\underline{h}}_{i} \cdot {\underline{P}}_{i - 1} \cdot {\underline{h}}_{i}^{H} , \qquad Eq ( 6 )$$

where rᵢ is a real-valued scalar. Equation (6) is referred to as the Riccati equation. Matrix Pᵢ may be initialized as

$${\underline{P}}_{0} = \frac{1}{{σ}_{n}^{2}} \cdot \underline{I} .$$

After performing R iterations of equation (6), for i=1, . . . , R, matrix P_{R} is provided as matrix P, or P=P_{R}.

Equation (6) may be factored to obtain the following:

$${\underline{P}}_{i} = {\underline{P}}_{i - 1} - \frac{{\underline{P}}_{i - 1} \cdot {\underline{h}}_{i}^{H} \cdot {\underline{h}}_{i} \cdot {\underline{P}}_{i - 1}}{{r}_{i}} \\ and \\ {r}_{i} = {σ}_{n}^{2} + {\underline{h}}_{i} \cdot {\underline{P}}_{i - 1} \cdot {\underline{h}}_{i}^{H} , \qquad Eq ( 7 )$$

where matrix Pᵢ is initialized as P₀=I and matrix P is derived as

$$\underline{P} = \frac{1}{{σ}_{n}^{2}} \cdot {\underline{P}}_{R} .$$

Equations (6) and (7) are different forms of a solution to equation (5). For simplicity, the same variables Pᵢ and rᵢ are used for both equations (6) and (7) even though these variables have different values in the two equations. The final results from equations (6) and (7), i.e., P_{R} for equation (6) and

$$\frac{1}{{σ}_{n}^{2}} \cdot {\underline{P}}_{R}$$

for equation (7), are equivalent. However, the calculations for the first iteration of equation (7) are simplified because P₀ is an identity matrix.

Each iteration of equation (7) may be performed as follows:
aᵢ=hᵢ·Pᵢ₋₁, Eq (8a)
rᵢ=σₙ²+aᵢ·hᵢ^{H}, Eq (8b)
Cᵢ=aᵢ^{H}·aᵢ, and Eq (8c)
Pᵢ=Pᵢ₋₁−rᵢ⁻¹·Cᵢ, Eq (8d)
where
aᵢ is a 1×T intermediate row vector of complex-valued elements; and
Cᵢ is a T×T intermediate Hermitian matrix.

In equation set (8), the sequence of operations is structured for efficient computation by hardware. Scalar rᵢ is computed before matrix Cᵢ. The division by rᵢ in equation (7) is achieved with an inversion and a multiply. The inversion of rᵢ may be performed in parallel with the computation of Cᵢ. The inversion of rᵢ may be achieved with a shifter to normalize rᵢ and a look-up table to produce an inverted rᵢ value. The normalization of rᵢ may be compensated for in the multiplication with Cᵢ.

Matrix Pᵢ is initialized as a Hermitian matrix, or P₀=I, and remains Hermitian through all of the iterations. Hence, only the upper (or lower) diagonal matrix needs to be calculated for each iteration. After R iterations are completed, matrix P is obtained as

$$\underline{P} = \frac{1}{{σ}_{n}^{2}} \cdot {\underline{P}}_{R} .$$

The MMSE spatial filter matrix may then be computed as follows:

$$\underline{M} = \underline{P} \cdot {\underline{H}}^{H} = \frac{1}{{σ}_{n}^{2}} \cdot {\underline{P}}_{R} \cdot {\underline{H}}^{H} . \qquad Eq ( 9 )$$

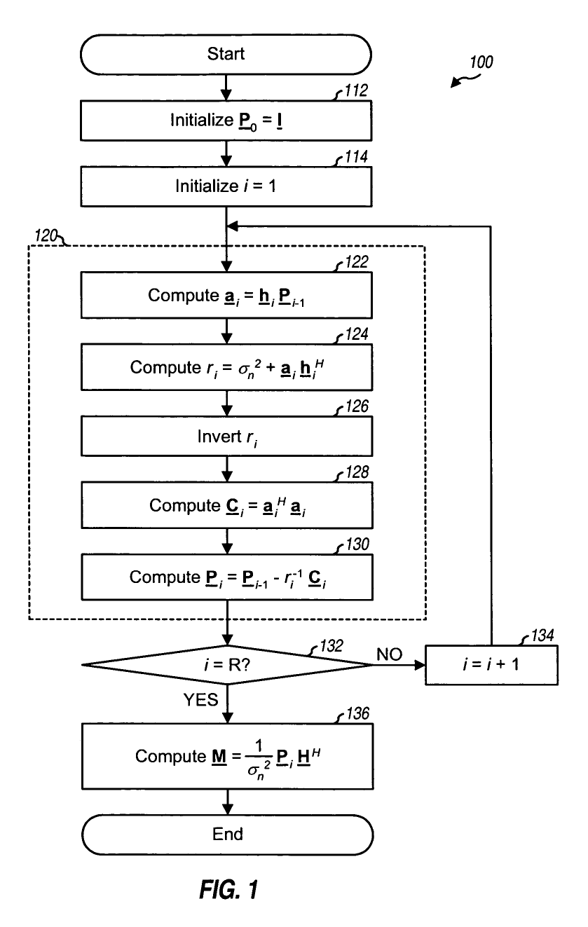

FIG. 1 shows a process 100 for computing the MMSE spatial filter matrix M based on the first embodiment. Matrix Pᵢ is initialized as P₀=I (block 112), and index i used to denote the iteration number is initialized as i=1 (block 114). R iterations of the Riccati equation are then performed.

Each iteration of the Riccati equation is performed by block 120. For the i-th iteration, the intermediate row vector aᵢ is computed based on the channel response row vector hᵢ and the Hermitian matrix Pᵢ₋₁ from the prior iteration, as shown in equation (8a) (block 122). The scalar rᵢ is computed based on the noise variance σₙ², the intermediate row vector aᵢ, and the channel response row vector hᵢ, as shown in equation (8b) (block 124). Scalar rᵢ is then inverted (block 126). Intermediate matrix Cᵢ is computed based on the intermediate row vector aᵢ, as shown in equation (8c) (block 128). Matrix Pᵢ is then updated based on the inverted scalar rᵢ and the intermediate matrix Cᵢ, as shown in equation (8d) (block 130).

A determination is then made whether all R iterations have been performed (block 132). If the answer is ‘No’, then index i is incremented (block 134), and the process returns to block 122 to perform another iteration. Otherwise, if all R iterations have been performed, then the MMSE spatial filter matrix M is computed based on the Hermitian matrix P_{R} for the last iteration, the channel response matrix H, and the noise variance σₙ², as shown in equation (9) (block 136). Matrix M may then be used for receiver spatial processing as shown in equation (3).

In a second embodiment of computing the MMSE spatial filter matrix M, the Hermitian matrix P is determined by deriving the square root of P, which is P^{1/2}, based on an iterative procedure. The receiver spatial processing in equation (3) may be expressed as:

$$\begin{matrix}\underline{\hat{s}} = {( {σ}_{n}^{2} \cdot \underline{I} + {\underline{H}}^{H} \cdot \underline{H} )}^{- 1} \cdot {\underline{H}}^{H} \cdot \underline{r} \\ = {( [ {\underline{H}}^{H} {σ}_{n} \cdot \underline{I} ] \cdot [ \begin{matrix}\underline{H} \\ {σ}_{n} \cdot \underline{I}\end{matrix} ] )}^{- 1} [ {\underline{H}}^{H} {σ}_{n} \cdot \underline{I} ] \cdot [ \begin{matrix}\underline{r} \\ {\underline{0}}_{T \times 1}\end{matrix} ] ,\end{matrix} \\ = {( {\underline{U}}^{H} \cdot \underline{U} )}^{- 1} \cdot {\underline{U}}^{H} \cdot [ \begin{matrix}\underline{r} \\ {\underline{0}}_{T \times 1}\end{matrix} ] = {\underline{U}}^{p} \cdot [ \begin{matrix}\underline{r} \\ {\underline{0}}_{T \times 1}\end{matrix} ] , \\ = {\underline{H}}_{σ}^{p} , \cdot \underline{r} , \qquad Eq ( 10 )$$

where

$$\underline{U} = [ \begin{matrix}\underline{H} \\ {σ}_{n} \cdot \underline{I}\end{matrix} ]$$

is a (R+T)×T augmented channel matrix;
U^{p} is a T×(R+T) pseudo-inverse matrix obtained from a Moore-Penrose inverse or a pseudo-inverse operation on U, or U^{p}=(U^{H}·U)⁻¹·U^{H};
0_{T×1} is a T×1 vector of all zeros; and
H_{σ}_{ₙ}^{p} is a T×R sub-matrix containing the first R columns of U^{p}.

QR decomposition may be performed on the augmented channel matrix, as follows:

$$[ \begin{matrix}\underline{H} \\ {σ}_{n} \cdot \underline{I}\end{matrix} ] = \underline{Q} \cdot \underline{R} = [ \begin{matrix}\underline{B} \\ {\underline{Q}}_{2}\end{matrix} ] \cdot \underline{R} , \qquad Eq ( 11 )$$

where
Q is a (R+T)×T matrix with orthonormal columns;
R is a T×T matrix that is non-singular;
B is an R×T matrix containing the first R rows of Q; and
Q₂ is a T×T matrix containing the last T rows of Q.

The QR decomposition in equation (11) decomposes the augmented channel matrix into an orthonormal matrix Q and a non-singular matrix R. An orthonormal matrix Q has the following property: Q^{H}·Q=I, which means that the columns of the orthonormal matrix are orthogonal to one another and each column has unit power. A non-singular matrix is a matrix that an inverse can be computed for.

The Hermitian matrix P may then be expressed as:

$$\begin{matrix}\underline{P} = {( {σ}_{n}^{2} \cdot \underline{I} + {\underline{H}}^{H} \cdot \underline{H} )}^{- 1} = {( [ {\underline{H}}^{H} {σ}_{n} \cdot \underline{I} ] [ \begin{matrix}\underline{H} \\ {σ}_{n} \cdot \underline{I}\end{matrix} ] )}^{- 1} , \\ = {( {( \underline{Q} \cdot \underline{R} )}^{H} \cdot \underline{Q} \cdot \underline{R} )}^{- 1} = {( {\underline{R}}^{H} \cdot {\underline{Q}}^{H} \cdot \underline{Q} \cdot \underline{R} )}^{- 1} , \\ = {( {\underline{R}}^{H} \cdot \underline{R} )}^{- 1} = {\underline{R}}^{- 1} \cdot {\underline{R}}^{- H} = {\underline{P}}^{1 / 2} \cdot {\underline{P}}^{H / 2} .\end{matrix} \qquad Eq ( 12 )$$

R is the Cholesky factorization or matrix square root of P⁻¹. Hence, P^{1/2} is equal to R⁻¹ and is called the square-root of P.

The pseudo-inverse matrix in equation (10) may then be expressed as:

$$\begin{matrix}{\underline{U}}^{p} = \underline{P} \cdot [ {\underline{H}}^{H} {σ}_{n} \cdot \underline{I} ] \\ = ( {\underline{R}}^{- 1} \cdot {\underline{R}}^{- H} ) \cdot ( {\underline{R}}^{H} \cdot {\underline{Q}}^{H} ) \\ = {\underline{R}}^{- 1} \cdot {\underline{Q}}^{H} \\ = {\underline{P}}^{1 / 2} \cdot {[ \begin{matrix}\underline{B} \\ {\underline{Q}}_{2}\end{matrix} ]}^{H} .\end{matrix} \qquad Eq ( 13 )$$

Sub-matrix H_{σ}_{ₙ}^{p}, which is also the MMSE spatial filter matrix, may then be expressed as:
H_{σ}_{ₙ}^{p}=M=P^{1/2}·B^{H}. Eq (14)

Equation (10) may then be expressed as:
ŝ=H_{σ}_{ₙ}^{p}·r=P^{1/2}·B^{H}·r=M·r. Eq (15)

Matrices P^{1/2} and B may be computed iteratively as follows:
Yᵢ·Θᵢ=Zᵢ, or Eq (16)

$$[ \begin{matrix}1 & {\underline{h}}_{i} \cdot {\underline{P}}_{i - 1}^{1 / 2} \\ {\underline{0}}_{T \times 1} & {\underline{P}}_{i - 1} \\ - {\underline{e}}_{i} & {\underline{B}}_{i - 1}\end{matrix} ] \cdot {\underline{Θ}}_{i} = [ \begin{matrix}{r}_{i}^{1 / 2} & {\underline{0}}_{1 \times T} \\ {\underline{k}}_{i} & {\underline{P}}_{i}^{1 / 2} \\ {\underline{I}}_{i} & {\underline{B}}_{i}\end{matrix} ] , \qquad Eq ( 17 )$$

where
Yᵢ is a (T+R+1)×(T+1) matrix containing elements derived based on Pᵢ₋₁^{1/2}, Bᵢ₋₁ and hᵢ;
Θᵢ is a (T+1)×(T+1) unitary transformation matrix;
Zᵢ is a (T+R+1)×(T+1) transformed matrix containing elements for Pᵢ^{1/2}, Bᵢ and rᵢ;
eᵢ is an R×1 vector with one (1.0) as the i-th element and zeros elsewhere; and
kᵢ is a T×1 vector and lᵢ is an R×1 vector, both of which are non-essential.
Matrices P^{1/2} and B are initialized as

$${\underline{P}}_{0}^{1 / 2} = \frac{1}{{σ}_{n}} \cdot \underline{I} and {\underline{B}}_{0} = {\underline{0}}_{R \times T} .$$

The transformation in equation (17) may be performed iteratively, as described below. For clarity, each iteration of equation (17) is called an outer iteration. R outer iterations of equation (17) are performed for the R channel response row vectors hᵢ, for i=1, . . . , R. For each outer iteration, the unitary transformation matrix Θᵢ in equation (17) results in the transformed matrix Zᵢ containing all zeros in the first row except for the first element. The first column of the transformed matrix Zᵢ contains rᵢ^{1/2}, kᵢ, and lᵢ. The last T columns of Zᵢ contain updated Pᵢ^{1/2} and Bᵢ. The first column of Zᵢ does not need to be calculated since only Pᵢ^{1/2} and Bᵢ are used in the next iteration. Pᵢ^{1/2} is an upper triangular matrix. After R outer iterations are completed, P_{R}^{1/2} is provided as P^{1/2}, and B_{R} is provided as B. The MMSE spatial filter matrix M may then be computed as based on P^{1/2} and B, as shown in equation (14).

For each outer iteration i, the transformation in equation (17) may be performed by successively zeroing out one element in the first row of Yᵢ at a time with a 2×2 Givens rotation. T inner iterations of the Givens rotation may be performed to zero out the last T elements in the first row of Yᵢ.

For each outer iteration i, a matrix Y_{i,j} may be initialized as Y_{i,1}=Yᵢ. For each inner iteration j, for j=1, . . . , T, of outer iteration i, a (T+R+1)×2 sub-matrix Y′_{i,j} containing the first and (j+1)-th columns of Y_{i,j} is initially formed. The Givens rotation is then performed on sub-matrix Y′_{i,j} to generate a (T+R+1)×2 sub-matrix Y″_{i,j} containing a zero for the second element in the first row. The Givens rotation may be expressed as:
Y″_{i,j}=Y′_{i,j}·G_{i,j}, Eq (18)
where G_{i,j} is a 2×2 Givens rotation matrix for the j-th inner iteration of the i-th outer iteration and is described below. Matrix Y_{i,j+1} is then formed by first setting Y_{i,j+1}=Y_{i,j}, then replacing the first column of Y_{i,j+1} with the first column of Y″_{i,j}, and then replacing the (j+1)-th column of Y_{i,j+1} with the second column of Y″_{i,j}. The Givens rotation thus modifies only two columns of Y_{i,j} in the j-th inner iteration to produce Y_{i,j+1} for the next inner iteration. The Givens rotation may be performed in-place on two columns of Yᵢ for each inner iteration, so that intermediate matrices Y_{i,j}, Y′_{i,j}, Y″_{i,j} and Y_{i,j+1} are not needed and are described above for clarity.

For the j-th inner iteration of the i-th outer iteration, the Givens rotation matrix G_{i,j} is determined based on the first element (which is always a real value) and the (j+1)-th element in the first row of Y_{i,j}. The first element may be denoted as a, and the (j+1)-th element may be denoted as b·e^{jθ}. The Givens rotation matrix G_{i,j} may then be derived as follows:

$${\underline{G}}_{i , j} = [ \begin{matrix}c & - s \\ s \cdot {ⅇ}^{- jθ} & c \cdot {ⅇ}^{- jθ}\end{matrix} ] = [ \begin{matrix}1 & 0 \\ 0 & {ⅇ}^{- jθ}\end{matrix} ] \cdot [ \begin{matrix}c & - s \\ s & c\end{matrix} ] , \qquad Eq ( 19 )$$

where

$$c = \frac{a}{\sqrt{{a}^{2} + {b}^{2}}} and s = \frac{b}{\sqrt{{a}^{2} + {b}^{2}}}$$

for equation (19).

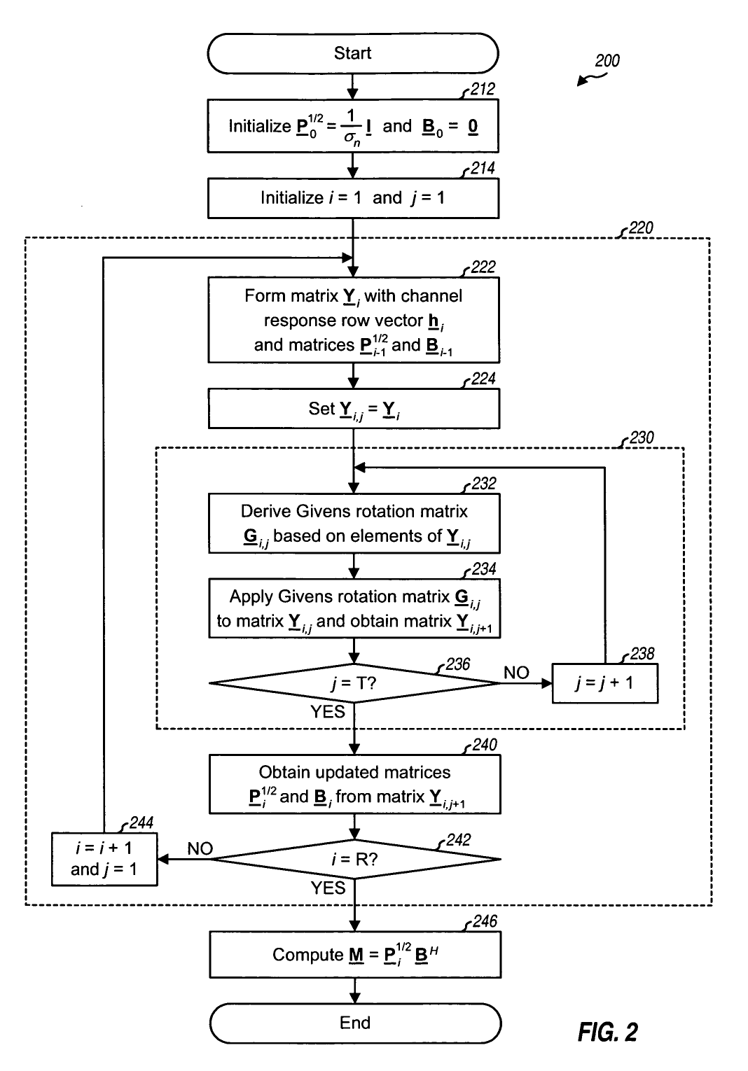

FIG. 2 shows a process 200 for computing the MMSE spatial filter matrix M based on the second embodiment. Matrix Pᵢ^{1/2} is initialized as

$${\underline{P}}_{0}^{1 / 2} = \frac{1}{σ} \cdot \underline{I} ,$$

and matrix Bᵢ is initialized as B₀=0 (block 212). Index i used to denote the outer iteration number is initialized as i=1, and index j used to denote the inner iteration number is initialized as j=1 (block 214). R outer iterations of the unitary transformation in equation (17) are then performed (block 220).

For the i-th outer iteration, matrix Yᵢ is initially formed with the channel response row vector hᵢ and matrices Pᵢ₋₁^{1/2} and Bᵢ₋₁, as shown in equation (17) (block 222). Matrix Yᵢ is then referred to as matrix Y_{i,j} for the inner iterations (block 224). T inner iterations of the Givens rotation are then performed on matrix Y_{i,j} (block 230).

For the j-th inner iteration, the Givens rotation matrix G_{i,j} is derived based on the first and (j+1)-th elements in the first row of Y_{i,j}, as shown in equation (19) (block 232). The Givens rotation matrix G_{i,j} is then applied to the first and (j+1)-th columns of Y_{i,j} to obtain Y_{i,j+1}, as shown in equation (18) (block 234). A determination is then made whether all T inner iterations have been performed (block 236). If the answer is ‘No’, then index j is incremented (block 238), and the process returns to block 232 to perform another inner iteration.

If all T inner iterations have been performed for the current outer iteration and the answer is ‘Yes’ for block 236, then the latest Y_{i,j+1} is equal to Zᵢ in equation (17). Updated matrices Pᵢ^{1/2} and Bᵢ are obtained from the latest Y_{i,j+1} (block 240). A determination is then made whether all R outer iterations have been performed (block 242). If the answer is ‘No’, then index i is incremented, and index j is reinitialized as j=1 (block 244). The process then returns to block 222 to perform another outer iteration with Pᵢ^{1/2} and Bᵢ. Otherwise, if all R outer iterations have been performed and the answer is ‘Yes’ for block 242, then the MMSE spatial filter matrix M is computed based on Pᵢ^{1/2} and Bᵢ, as shown in equation (14) (block 246). Matrix M may then be used for receiver spatial processing as shown in equation (15).

In a third embodiment of computing the MMSE spatial filter matrix M, eigenvalue decomposition of P⁻¹ is performed as follows:
P⁻¹=σₙ²·I+H^{H}·H=V·Λ·V^{H}, Eq (20)
where
V is a T×T unitary matrix of eigenvectors; and
Λ is a T×T diagonal matrix with real eigenvalues along the diagonal.

Eigenvalue decomposition of a 2×2 Hermitian matrix X_{2×2} may be achieved using various techniques. In an embodiment, eigenvalue decomposition of X_{2×2} is achieved by performing a complex Jacobi rotation on X_{2×2} to obtain a 2×2 matrix V_{2×2} of eigenvectors of X_{2×2}. The elements of X_{2×2} and V_{2×2} may be given as:

$${\underline{X}}_{2 \times 2} = [ \begin{matrix}{x}_{1 , 1} & {x}_{1 , 2} \\ {x}_{2 , 1} & {x}_{2 , 2}\end{matrix} ] \\ and \\ {\underline{V}}_{2 \times 2} = [ \begin{matrix}{v}_{1 , 1} & {v}_{1 , 2} \\ {v}_{2 , 1} & {v}_{2 , 2}\end{matrix} ] \qquad Eq ( 21 )$$

The elements of V_{2×2} may be computed directly from the elements of X_{2×2}, as follows:

$$\begin{matrix}r = \sqrt{{( Re \{ {x}_{1 , 2} \} )}^{2} + {( Im \{ {x}_{1 , 2} \} )}^{2}} , & Eq ( 22 a ) \\ {c}_{1} = \frac{Re \{ {x}_{1 , 2} \}}{r} = cos ( ∠ {x}_{1 , 2} ) , & Eq ( 22 b ) \\ {s}_{1} = \frac{Im \{ {x}_{1 , 2} \}}{r} = sin ( {∠x}_{1 , 2} ) , & Eq ( 22 c ) \\ {g}_{1} = {c}_{1} - {js}_{1} , & Eq ( 22 d ) \\ τ = \frac{{x}_{2 , 2} - {x}_{1 , 1}}{2 \cdot r} , & Eq ( 22 e ) \\ x = \sqrt{1 + {τ}^{2}} , & Eq ( 22 f ) \\ t = \frac{1}{\vert τ \vert + x} , & Eq ( 22 g ) \\ c = \frac{1}{\sqrt{1 + {t}^{2}} ,} & Eq ( 22 h ) \\ s = t \cdot c = \sqrt{1 - {c}^{2}} , \\ if \\ ( {x}_{2 , 2} - {x}_{1 , 1} ) < 0 & Eq ( 22 i ) \\ then \\ {\underline{V}}_{2 \times 2} = [ \begin{matrix}c & - s \\ {g}_{1} \cdot s & {g}_{1} \cdot c\end{matrix} ] , & Eq ( 22 j ) \\ else \\ {\underline{V}}_{2 \times 2} = [ \begin{matrix}s & c \\ {g}_{1} \cdot c & - {g}_{1} \cdot s\end{matrix} ] . & Eq ( 22 k )\end{matrix}$$

Eigenvalue decomposition of a T×T Hermitian matrix X that is larger than 2×2 may be performed with an iterative process. This iterative process uses the Jacobi rotation repeatedly to zero out off-diagonal elements in X. For the iterative process, index i denotes the iteration number and is initialized as i=1. X is a T×T Hermitian matrix to be decomposed and is set as X=P⁻¹. Matrix Dᵢ is an approximation of diagonal matrix Λ in equation (20) and is initialized as D₀=X. Matrix Vᵢ is an approximation of unitary matrix V in equation (20) and is initialized as V₀=I.

A single iteration of the Jacobi rotation to update matrices Dᵢ and Vᵢ may be performed as follows. First, a 2×2 Hermitian matrix D_{pq} is formed based on the current matrix Dᵢ, as follows:

$${\underline{D}}_{pq} = [ \begin{matrix}{d}_{p , p} & {d}_{p , q} \\ {d}_{q , p} & {d}_{q , q}\end{matrix} ] , \qquad Eq ( 23 )$$

where d_{p,q} is the element at location (p,q) in Dᵢ, pε{1, . . . , T}, qε{1, . . . , T}, and p≠q. D_{pq} is a 2×2 submatrix of Dᵢ, and the four elements of D_{pq} are four elements at locations (p,p), (p,q), (q,p) and (q,q) in Dᵢ. Indices p and q may be selected as described below.

Eigenvalue decomposition of D_{pq} is then performed as shown in equation set (22) to obtain a 2×2 unitary matrix V_{pq} of eigenvectors of D_{pq}. For the eigenvalue decomposition of D_{pq}, X_{2×2} in equation (21) is replaced with D_{pq}, and V_{2×2} from equation (22j) or (22k) is provided as V_{pq}.

A T×T complex Jacobi rotation matrix T_{pq} is then formed with V_{pq}. T_{pq} is an identity matrix with four elements at locations (p,p), (p,q), (q,p) and (q,q) replaced with elements v_{1,1}, v_{1,2}, v_{2,1}, and v_{2,2}, respectively, in V_{pq}.

Matrix Dᵢ is then updated as follows:
Dᵢ₊₁=T_{pq}^{H}·Dᵢ·T_{pq}. Eq (24)
Equation (24) zeros out two off-diagonal elements at locations (p,q) and (q,p) in Dᵢ. The computation may alter the values of other off-diagonal elements in Dᵢ.

Matrix Vᵢ is also updated as follows:
Vᵢ₊₁=Vᵢ·T_{pq}. Eq (25)
Vᵢ may be viewed as a cumulative transformation matrix that contains all of the Jacobi rotation matrices T_{pq} used on Dᵢ.

Each iteration of the Jacobi rotation zeros out two off-diagonal elements of Dᵢ. Multiple iterations of the Jacobi rotation may be performed for different values of indices p and q to zero out all of the off-diagonal elements of Dᵢ. A single sweep across all possible values of indices p and q may be performed as follows. Index p is stepped from 1 through T−1 in increments of one. For each value of p, index q is stepped from p+1 through T in increments of one. The Jacobi rotation is performed for each different combination of values for p and q. Multiple sweeps may be performed until Dᵢ and Vᵢ are sufficiently accurate estimates of Λ and V, respectively.

Equation (20) may be rewritten as follows:
P=(σₙ²·I+H^{H}·H)⁻¹=V·Λ⁻¹·V^{H}, Eq (26)
where Λ⁻¹ is a diagonal matrix whose elements are the inverse of the corresponding elements in Λ. The eigenvalue decomposition of X=P⁻¹ provides estimates of Λ and V. Λ may be inverted to obtain Λ⁻¹.

The MMSE spatial filter matrix may then be computed as follows:
M=P·H^{H}=V·Λ⁻¹·V^{H}·H^{H}. Eq (27)

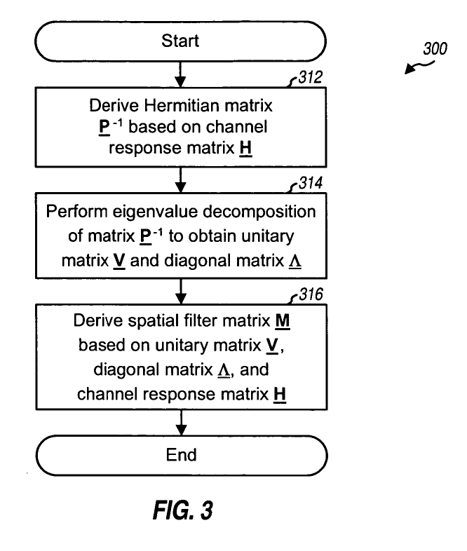

FIG. 3 shows a process 300 for computing the MMSE spatial filter matrix M based on the third embodiment. Hermitian matrix P⁻¹ is initially derived based on the channel response matrix H, as shown in equation (20) (block 312). Eigenvalue decomposition of P⁻¹ is then performed to obtain unitary matrix V and diagonal matrix Λ, as also shown in equation (20) (block 314). The eigenvalue decomposition may be iteratively performed with a number of Jacobi rotations, as described above. The MMSE spatial filter matrix M is then derived based on the unitary matrix V, the diagonal matrix Λ, and the channel response matrix H, as shown in equation (27) (block 316).

The MMSE spatial filter matrix M derived based on each of the embodiments described above is a biased MMSE solution. The biased spatial filter matrix M may be scaled by a diagonal matrix Dₘₘₛₑ to obtain an unbiased MMSE spatial filter matrix Mₘₘₛₑ. Matrix Dₘₘₛₑ may be derived as Dₘₘₛₑ=[diag[M·H]]⁻¹, where diag[M·H] is a diagonal matrix containing the diagonal elements of M·H.

The computation described above may also be used to derive spatial filter matrices for a zero-forcing (ZF) technique (which is also called a channel correlation matrix inversion (CCMI) technique), a maximal ratio combining (MRC) technique, and so on. For example, the receiving station may perform zero-forcing and MRC receiver spatial processing, as follows:
ŝ_{zf}=(H^{H}·H)⁻¹·H^{H}·r=P_{zf}·H^{H}·r=M_{zf}·r, Eq (28)
ŝ_{mrc}=[diag(H^{H}·H)⁻¹]H^{H}·r=[diag(P_{zf})]·H^{H}·r=M_{mrc}·r, Eq (29)
where
M_{zf} is a T×R zero-forcing spatial filter matrix;
M_{mrc} is a T×R MRC spatial filter matrix;
P_{zf}=(H^{H}·H)⁻¹ is a T×T Hermitian matrix; and
[diag(P_{zf})] is a T×T diagonal matrix containing the diagonal elements of P_{zf}.
   A matrix inversion is needed to compute P_{zf} directly. P_{zf} may be computed using the embodiments described above for the MMSE spatial filter matrix.

The description above assumes that T modulation symbols are sent simultaneously from T transmit antennas without any spatial processing. The transmitting station may perform spatial processing prior to transmission, as follows:
x=W·s, Eq (30)
where
x is a T×1 vector with T transmit symbols to be sent from the T transmit antennas; and
W is a T×S transmit matrix.
   Transmit matrix W may be (1) a matrix of right singular vectors obtained by performing singular value decomposition of H, (2) a matrix of eigenvectors obtained by performing eigenvalue decomposition of H^{H}·H, or (3) a steering matrix selected to spatially spread the modulation symbols across the S spatial channels of the MIMO channel. An effective channel response matrix H_{eff} observed by the modulation symbols may then be given as H_{eff}=H·W. The computation described above may be performed based on H_{eff} instead of H.

For clarity, the description above is for a single-carrier MIMO system with a single subband. For a multi-carrier MIMO system, a channel response matrix H(k) may be obtained for each subband k of interest. A spatial filter matrix M(k) may then be derived for each subband k based on the channel response matrix H(k) for that subband.

The computation described above for the spatial filter matrix may be performed using various types of processors such as a floating-point processor, a fixed-point processor, a Coordinate Rotational Digital Computer (CORDIC) processor, a look-up table, and so on, or a combination thereof. A CORDIC processor implements an iterative algorithm that allows for fast hardware calculation of trigonometric functions such as sine, cosine, magnitude, and phase using simple shift and add/subtract hardware. A CORDIC processor may iteratively compute each of variables r, c₁ and s₁ in equation set (22), with more iterations producing higher accuracy for the variable.

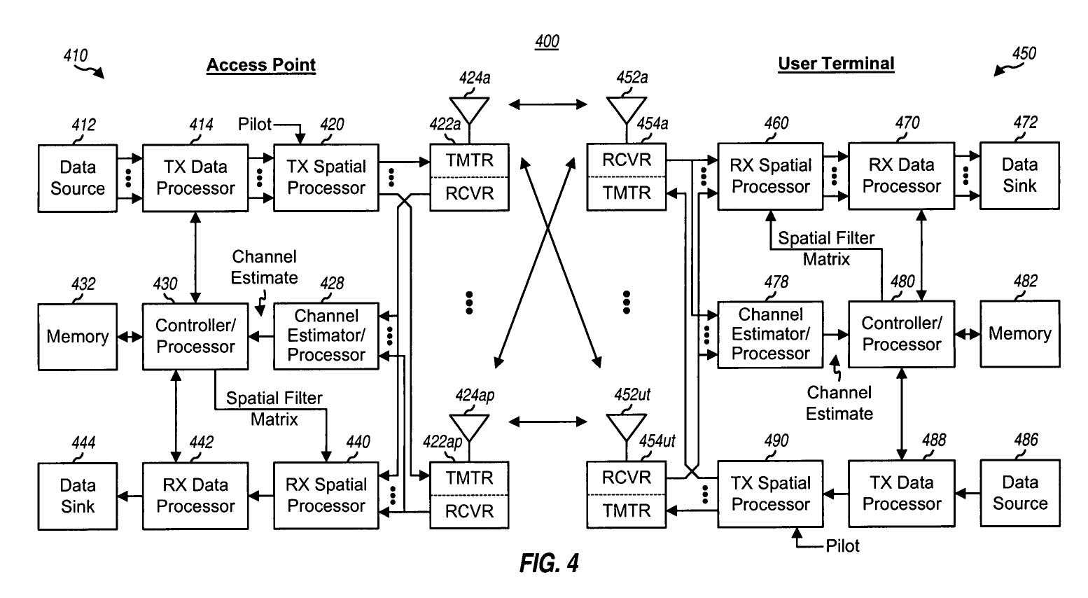

FIG. 4 shows a block diagram of an access point 410 and a user terminal 450 in a MIMO system 400. Access point 410 is equipped with Nₐₚ antennas and user terminal 450 is equipped with Nᵤₜ antennas, where Nₐₚ>1 and Nᵤₜ>1. On the downlink, at access point 410, a transmit (TX) data processor 414 receives traffic data from a data source 412 and other data from a controller/processor 430. TX data processor 414 formats, encodes, interleaves, and modulates the data and generates data symbols, which are modulation symbols for data. A TX spatial processor 420 multiplexes the data symbols with pilot symbols, performs spatial processing with transmit matrix W if applicable, and provides Nₐₚ streams of transmit symbols. Each transmitter unit (TMTR) 422 processes a respective transmit symbol stream and generates a downlink modulated signal. Nₐₚ downlink modulated signals from transmitter units 422a through 422ap are transmitted from antennas 424a through 424ap, respectively.

At user terminal 450, Nᵤₜ antennas 452a through 452ut receive the transmitted downlink modulated signals, and each antenna provides a received signal to a respective receiver unit (RCVR) 454. Each receiver unit 454 performs processing complementary to the processing performed by transmitter units 422 and provides received pilot symbols and received data symbols. A channel estimator/processor 478 processes the received pilot symbols and provides an estimate of the downlink channel response H_{dn}. A processor 480 derives a downlink spatial filter matrix M_{dn} based on H_{dn} and using any of the embodiments described above. A receive (RX) spatial processor 460 performs receiver spatial processing (or spatial matched filtering) on the received data symbols from all Nᵤₜ receiver units 454a through 454ut with the downlink spatial filter matrix M_{dn} and provides detected data symbols, which are estimates of the data symbols transmitted by access point 410. An RX data processor 470 processes (e.g., symbol demaps, deinterleaves, and decodes) the detected data symbols and provides decoded data to a data sink 472 and/or controller 480.

The processing for the uplink may be the same or different from the processing for the downlink. Data from a data source 486 and signaling from controller 480 are processed (e.g., encoded, interleaved, and modulated) by a TX data processor 488, multiplexed with pilot symbols, and possibly spatially processed by TX spatial processor 490. The transmit symbols from TX spatial processor 490 are further processed by transmitter units 454a through 454ut to generate Nᵤₜ uplink modulated signals, which are transmitted via antennas 452a through 452ut.

At access point 410, the uplink modulated signals are received by antennas 424a through 424ap and processed by receiver units 422a through 422ap to generate received pilot symbols and received data symbols for the uplink transmission. A channel estimator/processor 428 processes the received pilot symbols and provides an estimate of the uplink channel response Hᵤₚ. Processor 430 derives an uplink spatial filter matrix Mᵤₚ based on Hᵤₚ and using any of the embodiments described above. An RX spatial processor 440 performs receiver spatial processing on the received data symbols with the uplink spatial filter matrix Mᵤₚ and provides detected data symbols. An RX data processor 442 further processes the detected data symbols and provides decoded data to a data sink 444 and/or controller 430.

Controllers 430 and 480 control the operation at access point 410 and user terminal 450, respectively. Memory units 432 and 482 store data and program codes used by controllers 430 and 480, respectively.

The blocks in FIGS. 1 through 4 represent functional blocks that may be embodied in hardware (one or more devices), firmware (one or more devices), software (one or more modules), or combinations thereof. For example, the filter weight computation techniques described herein may be implemented in hardware, firmware, software, or a combination thereof. For a hardware implementation, the processing units used to compute the filter weights may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. The various processors at access point 410 in FIG. 4 may also be implemented with one or more hardware processors. Likewise, the various processors at user terminal 450 may be implemented with one or more hardware processors.

For a firmware or software implementation, the filter weight computation techniques may be implemented with modules (e.g., procedures, functions, and so on) that perform the functions described herein. The software codes may be stored in a memory unit (e.g., memory unit 432 or 482 in FIG. 4) and executed by a processor (e.g., processor 430 or 480). The memory unit may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
a first processor operative to derive a channel response matrix; and
a second processor operative to derive a first matrix iteratively based on the channel response matrix and to derive a spatial filter matrix based on the first matrix and the channel response matrix, wherein the second processor indirectly calculates a matrix inversion by deriving the first matrix iteratively.

2. The apparatus of claim 1, wherein the second processor is operative to initialize the first matrix to an identity matrix.

3. The apparatus of claim 1, wherein the second processor is operative, for each of a plurality of iterations, to derive an intermediate row vector based on the first matrix and a channel response row vector corresponding to a row of the channel response matrix, to derive a scalar based on the intermediate row vector and the channel response row vector, to derive an intermediate matrix based on the intermediate row vector, and to update the first matrix based on the scalar and the intermediate matrix.

4. The apparatus of claim 1, wherein the first matrix is for a minimum mean square error (MMSE) spatial filter matrix.

5. The apparatus of claim 1, wherein the second processor is operative to derive the first matrix based on the following equation:
$${\underline{P}}_{i} = {\underline{P}}_{i - 1} - \frac{{\underline{P}}_{i - 1} \cdot {\underline{h}}_{i}^{H} \cdot {\underline{h}}_{i} \cdot {\underline{P}}_{i - 1}}{{r}_{i}} ,$$
where Pᵢ is the first matrix for i-th iteration, hᵢ is i-th row of the channel response matrix, rᵢ is a scalar derived based on hᵢ and Pᵢ₋₁, and “^{H}” is a conjugate transpose.

6. The apparatus of claim 1, wherein the second processor is operative to derive the first matrix based on the following equations:
aᵢ=hᵢ·Pᵢ₋₁,
rᵢ=σₙ²+aᵢ·hᵢ^{H},
Cᵢ=aᵢ^{H}·aᵢ, and
Pᵢ=Pᵢ₋₁−rᵢ⁻¹·Cᵢ,
where Pᵢ is the first matrix for i-th iteration, hᵢ is i-th row of the channel response matrix, aᵢ is an intermediate row vector for the i-th iteration, Cᵢ is an intermediate matrix for the i-th iteration, rᵢ is a scalar for the i-th iteration, σₙ² is noise variance, and “^{H}” is a conjugate transpose.

7. The apparatus of claim 1, wherein the second processor is operative to derive the spatial filter matrix based on the following equation:
M=P·H^{H},
where M is the spatial filter matrix, P is the first matrix, H is the channel response matrix, and “^{H}” is a conjugate transpose.

8. A method of deriving a spatial filter matrix, comprising:
deriving a first matrix iteratively based on a channel response matrix, wherein a matrix inversion is indirectly calculated by deriving the first matrix iteratively; and
deriving the spatial filter matrix based on the first matrix and the channel response matrix.

9. The method of claim 8, further comprising:
initializing the first matrix to an identity matrix.

10. The method of claim 8, wherein the deriving the first matrix comprises, for each of a plurality of iterations,
deriving an intermediate row vector based on the first matrix and a channel response row vector corresponding to a row of the channel response matrix,
deriving a scalar based on the intermediate row vector and the channel response row vector,
deriving an intermediate matrix based on the intermediate row vector, and
updating the first matrix based on the scalar and the intermediate matrix.

11. An apparatus comprising:
means for deriving a first matrix iteratively based on a channel response matrix, wherein a matrix inversion is indirectly calculated by deriving the first matrix iteratively; and
means for deriving a spatial filter matrix based on the first matrix and the channel response matrix.

12. The apparatus of claim 11, further comprising:
means for initializing the first matrix to an identity matrix.

13. The apparatus of claim 11, wherein the means for deriving the first matrix comprises, for each of a plurality of iterations,
means for deriving an intermediate row vector based on the first matrix and a channel response row vector corresponding to a row of the channel response matrix,
means for deriving a scalar based on the intermediate row vector and the channel response row vector,
means for deriving an intermediate matrix based on the intermediate row vector, and
means for updating the first matrix based on the scalar and the intermediate matrix.

14. An apparatus comprising:
a first processor operative to derive a channel response matrix; and
a second processor operative to perform a plurality of rotations to iteratively obtain a first matrix and a second matrix for a pseudo-inverse matrix of the channel response matrix and to derive a spatial filter matrix based on the first and second matrices.

15. The apparatus of claim 14, wherein the second processor is operative to initialize the first matrix to an identity matrix and to initialize the second matrix with all zeros.

16. The apparatus of claim 14, wherein the second processor is operative, for each of a plurality of rows of the channel response matrix, to form an intermediate matrix based on the first matrix, the second matrix, and a channel response row vector, and to perform at least two rotations on the intermediate matrix to zero out at least two elements of the intermediate matrix.

17. The apparatus of claim 14, wherein the second processor is operative to perform a Givens rotation for each of the plurality of rotations to zero out one element of an intermediate matrix containing the first and second matrices.

18. The apparatus of claim 14, wherein the pseudo-inverse matrix is for a minimum mean square error (MMSE) spatial filter matrix.

19. The apparatus of claim 14, wherein the second processor is operative to perform at least two rotations for each of a plurality of iterations based on the following equation:
$$[ \begin{matrix}1 & {\underline{h}}_{i} \cdot {\underline{P}}_{i - 1}^{1 / 2} \\ 0 & {\underline{P}}_{i - 1}^{1 / 2} \\ - {\underline{e}}_{i} & {\underline{B}}_{i - 1}\end{matrix} ] \cdot {\underline{Θ}}_{i} = [ \begin{matrix}{r}_{i}^{1 / 2} & \underline{0} \\ {\underline{k}}_{i} & {\underline{P}}_{i}^{1 / 2} \\ {\underline{I}}_{i} & {\underline{B}}_{i}\end{matrix} ] ,$$
where Pᵢ^{1/2} is the first matrix for i-th iteration, Bᵢ is the second matrix for the i-th iteration, hᵢ is i-th row of the channel response matrix, eᵢ is a vector with one for i-th element and zeros elsewhere, kᵢ and lᵢ are non-essential vectors, rᵢ^{1/2} is a scalar, 0 is a vector with all zeros, and Θᵢ is a transformation matrix representing the at least two rotations for the i-th iteration.

20. The apparatus of claim 14, wherein the second processor is operative to derive the spatial filter matrix based on the following equation:
M=P^{1/2}·B^{H},
where M is the spatial filter matrix, P^{1/2} is the first matrix, B is the second matrix, and “^{H}” is a conjugate transpose.

21. A method of deriving a spatial filter matrix, comprising:
performing a plurality of rotations to iteratively obtain a first matrix and a second matrix for a pseudo-inverse matrix of a channel response matrix; and
deriving the spatial filter matrix based on the first and second matrices.

22. The method of claim 21, wherein the performing the plurality of rotations comprises, for each of a plurality of iterations,
forming an intermediate matrix based on the first matrix, the second matrix, and a channel response row vector corresponding to a row of the channel response matrix, and
performing at least two rotations on the intermediate matrix to zero out at least two elements of the intermediate matrix.

23. The method of claim 21, wherein the performing the plurality of rotations comprises
performing a Givens rotation for each of the plurality of rotations to zero out one element of an intermediate matrix containing the first and second matrices.

24. An apparatus comprising:
means for performing a plurality of rotations to iteratively obtain a first matrix and a second matrix for a pseudo-inverse matrix of a channel response matrix; and
means for deriving a spatial filter matrix based on the first and second matrices.

25. The apparatus of claim 24, wherein the means for performing the plurality of rotations comprises, for each of a plurality of iterations,
means for forming an intermediate matrix based on the first matrix, the second matrix, and a channel response row vector corresponding to a row of the channel response matrix, and
means for performing at least two rotations on the intermediate matrix to zero out at least two elements of the intermediate matrix.

26. The apparatus of claim 24, wherein the means for performing the plurality of rotations comprises
means for performing a Givens rotation for each of the plurality of rotations to zero out one element of an intermediate matrix containing the first and second matrices.

27. An apparatus comprising:
a first processor operative to derive a channel response matrix; and
a second processor operative to derive a first matrix based on the channel response matrix, to decompose the first matrix to obtain a unitary matrix and a diagonal matrix, and to derive the spatial filter matrix based on the unitary matrix, the diagonal matrix, and the channel response matrix.

28. The apparatus of claim 27, wherein the second processor is operative to perform eigenvalue decomposition of the first matrix to obtain the unitary matrix and the diagonal matrix.

29. The apparatus of claim 27, wherein the second processor is operative to perform a plurality of Jacobi rotations on the first matrix to obtain the unitary matrix and the diagonal matrix.

30. The apparatus of claim 27, wherein the second processor is operative to derive the first matrix based on the following equation:
X=σₙ²·I+H^{H}·H,
where X is the first matrix, H is the channel response matrix, I is an identity matrix, σₙ² is noise variance, and “^{H}” is a conjugate transpose.

31. The apparatus of claim 27, wherein the second processor is operative to derive the spatial filter matrix based on the following equation:
M=V·Λ⁻¹·V^{H}·H^{H},
where M is the spatial filter matrix, H is the channel response matrix, V is the unitary matrix, Λ is the diagonal matrix, and “^{H}” is a conjugate transpose.

32. A method of deriving a spatial filter matrix, comprising:
deriving a first matrix based on a channel response matrix;
decomposing the first matrix to obtain a unitary matrix and a diagonal matrix; and
deriving the spatial filter matrix based on the unitary matrix, the diagonal matrix, and the channel response matrix.

33. The method of claim 32, wherein the decomposing the first matrix comprises
performing eigenvalue decomposition of the first matrix to obtain the unitary matrix and the diagonal matrix.

34. The method of claim 32, wherein the decomposing the first matrix comprises
performing a plurality of Jacobi rotations on the first matrix to obtain the unitary matrix and the diagonal matrix.

35. An apparatus comprising:
means for deriving a first matrix based on a channel response matrix;
means for decomposing the first matrix to obtain a unitary matrix and a diagonal matrix; and
means for deriving a spatial filter matrix based on the unitary matrix, the diagonal matrix, and the channel response matrix.

36. The apparatus of claim 35, wherein the means for decomposing the first matrix comprises
means for performing eigenvalue decomposition of the first matrix to obtain the unitary matrix and the diagonal matrix.

37. The apparatus of claim 35, wherein the means for decomposing the first matrix comprises
means for performing a plurality of Jacobi rotations on the first matrix to obtain the unitary matrix and the diagonal matrix.
